(19) United States
(12) Patent Application Publication
(10) Pub. No.: US 2026/0175547 A1
(43) Pub. Date: Jun. 25, 2026

(54) DEGRADABLE PLASTIC COMPACT

(71) Applicant: HONOR PACKAGING TECHNOLOGY (HUIZHOU) CO.,LTD, Huizhou (CN)

(72) Inventors: HU LIN, Shenzhen (CN); LIANG TAN, Shenzhen (CN)

(21) Appl. No.: 19/537,648

(22) Filed: Feb. 12, 2026

(51) Int. Cl. B32B 27/32; B32B 1/00

(52) U.S. Cl. CPC B32B 27/32; B32B 1/00; B65D 2543/00509

(57) ABSTRACT

Provided is a degradable plastic compact, which includes a bottom cover. An inner side of the bottom cover is provided with a bottom frame, an inner side of the bottom frame is provided with a powder compact, an inner side of the powder compact is filled with makeup powder. An upper end surface of the bottom frame is provided with an upper cover. One end of the upper cover is rotatably connected to two plastic nails, and axes of the two plastic nails coincide. The two plastic nails are inserted into the inner side of the bottom frame. The upper cover and the bottom frame are rotatably connected by the two plastic nails. Two positioning convex blocks are provided on an inner side of one end of the bottom frame, and one side of the positioning convex blocks is provided with an arc-shaped recess.

### TECHNICAL FIELD

The present disclosure relates to the field of cosmetics technologies, and in particular, to a new type of fully degradable plastic compact.

### BACKGROUND

Powder compact refers to a common beauty product, usually a box containing cosmetics such as loose powder, make-up foundation or powder blusher. In the cosmetics industry, the design of powder compacts is generally exquisite and can attract consumers' attention. Different materials, shapes, colors, and patterns of powder compacts can provide consumers with different visual experiences and are also an important part of brand building. Powder compacts are one of the packaging forms of cosmetics, which can conveniently protect cosmetics and prevent external factors such as dust and bacteria from contaminating cosmetics. With the deepening of environmental protection concepts, the market needs powder compact packaging that is easy to recycle and has environmentally friendly and biodegradable materials.

The existing makeup powder compact is provided with glass and metal parts (such as metal pin or hinges), which are not conducive to degradation and recycling. Moreover, Lid and base of the compact are connected by a buckle method, and a rotation of the lid and bottom cannot be well positioned, and the lid and bottom are prone to detachment which does not meet the existing need. Therefore, a new type of fully degradable plastic compact is provided.

### SUMMARY

The purpose of the present disclosure is to provide a new type of fully degradable plastic compact, which solves problems of the existing cosmetic powder compact with glass lenses and metal teeth nails, which are not conducive to degradation and recycling, and the problem of difficult positioning of the lid-bottom rotation and easy detachment of the lid-bottom through the buckle connection method, as proposed in the background technology.

To achieve the above objectives, the present disclosure provides the following technical solution: a degradable plastic compact, including: a bottom cover, where a bottom frame is provided on an inner side of the bottom cover, a powder compact is provided on an inner side of the bottom frame, an inner side of the powder compact is filled with makeup powder, and an upper cover is provided on an upper end face of the bottom frame; two plastic nails are rotatably connected to an inner side of one end of the upper cover, and axes of the two plastic nails coincide; the two plastic nails are inserted into the inner side of the bottom frame, and the upper cover is rotatably connected to the bottom frame through the two plastic nails, an inner side of one end of the bottom frame is provided with two positioning convex blocks, and one side of the positioning convex blocks is provided with an arc-shaped recess; two sides of one end of the upper cover are provided with positioning recesses.

In some embodiments of the present disclosure, a label layer is provided in a middle of an upper end face of the upper cover, the bottom cover is clamped with the bottom frame, materials of the upper cover, the bottom cover, the bottom frame, the powder compact and the plastic nails are all degradable Polyethylene terephthalate, (PET) plastic, the bottom frame and the two positioning convex blocks are injection molded as a whole, the bottom frame and one end of the upper cover are clamping connected by the two positioning convex blocks and the positioning recesses; the positioning convex blocks are suspended relative to the arc-shaped recess.

In some embodiments of the present disclosure, a plastic mirror is adhered and fixed to an inner wall of the upper cover, and material of the upper cover is opaque PET plastic.

In some embodiments of the present disclosure, material of the upper cover is transparent PET plastic.

In some embodiments of the present disclosure, outer surfaces of the plastic nails are provided with a plurality of positioning convex strips, and inner sides of two ends of the plastic nails are fixedly provided with reinforcement ribs; the plastic nails, the positioning convex strips, and the reinforcement ribs are injection molded as a whole.

In some embodiments of the present disclosure, outer surfaces of the plastic nails are provided with a plurality of positioning convex strips, and two ends of the plastic nails are provided with reinforcement grooves; the plastic nails and the plurality of positioning convex strips are injection molded as a whole.

In some embodiments of the present disclosure, outer surfaces of the plastic nails are provided with a plurality of positioning convex strips, one end of the plastic nails is provided with an anti-deviation groove, and inner sides of two ends of the plastic nails are provided with central holes; adjacent two central holes are not communicated, and the plastic nails and the plurality of positioning convex strips are injection molded as a whole.

Compared with existing technology, the beneficial effects of the present disclosure are as follows.
1. The present disclosure uses the powder compact to facilitate the storage of makeup powder through the bottom frame and is sealed and closed through the upper cover. The materials of the upper cover, the bottom cover, the bottom frame, the powder compact, and the plastic nails are all biodegradable PET plastic, which can achieve overall degradation and recycling operations, and is conducive to environmental protection. The upper cover rotates relative to the bottom frame through the plastic nails, and during a rotation process, the plastic nails interfere with the upper cover through positioning convex blocks to achieve rotation positioning and non-detachment. The two positioning recesses are provided on two sides of one end of the upper cover. By hiding the positioning convex blocks and positioning recess, the overall aesthetic effect can be improved.
2. The present disclosure is provided with the arc-shaped recess on the side of the positioning convex blocks, which can make the positioning convex blocks in a suspended state, thereby providing greater elastic space when the positioning convex blocks and the positioning recess are engaged and separated, thereby improving the service life of the positioning convex blocks. When the upper cover and the bottom cover are closed, the positioning convex blocks and the positioning recess are engaged with each other, thereby maintaining the stability of the upper cover in a closed state and avoiding accidental contact that may cause the powder inside the powder compact to spill.

### BRIEF DESCRIPTION OF DRAWINGS

FIG. 1 is a schematic diagram of an overall structure of the present disclosure.

FIG. 2 is a schematic diagram of an opaque state of an upper cover of the present disclosure.

FIG. 3 is a schematic structural diagram of a transparent state of the upper cover of the present disclosure.

FIG. 4 is a schematic diagram of a cross-sectional structure of a bottom frame of the present disclosure.

FIG. 5 is a schematic diagram of an overall explosion structure of the present disclosure.

FIG. 6 is a schematic diagram of a cross-sectional structure of a plastic nail of the present disclosure.

FIG. 7 is a schematic structural diagram of a reinforcement rib of the present disclosure.

FIG. 8 is a schematic structural diagram of a reinforcement groove of the present disclosure.

FIG. 9 is a schematic structural diagram of a central hole of the present disclosure.

Numeral Reference: 1—upper cover; 2—label layer; 3—bottom cover; 4—arc-shaped recess; 5—bottom frame; 6—plastic mirror; 7—powder compact; 8—central hole; 9—anti deviation groove; 10—positioning convex block; 11—positioning recess; 12—plastic nail; 13—reinforcement rib; 14—reinforcement groove; 15—positioning convex strip.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them.

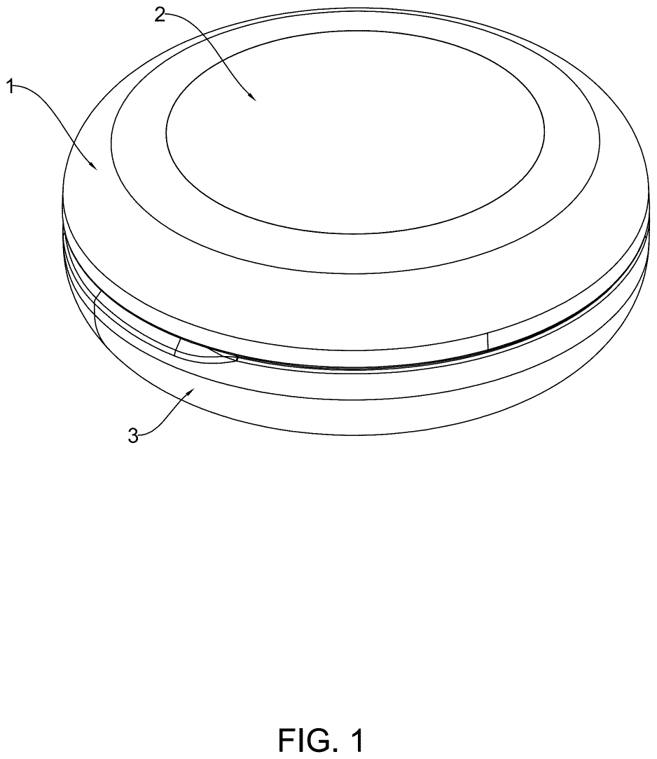

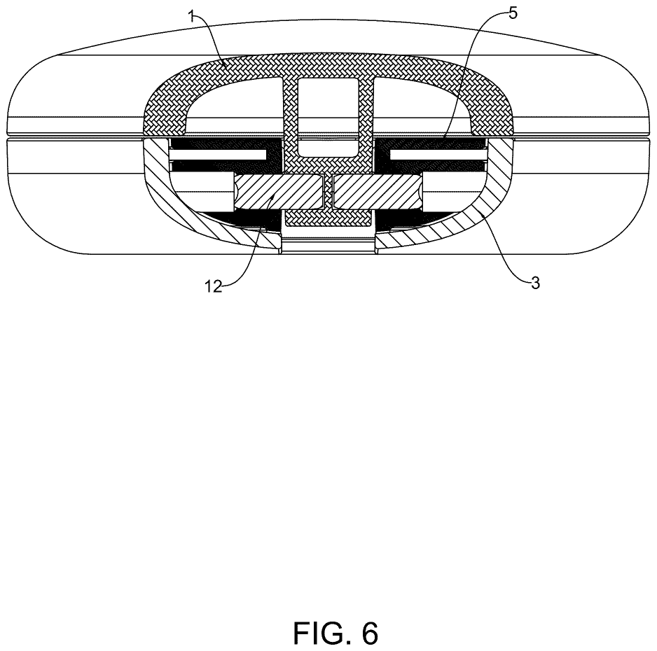

Please refer to FIGS. 1, 5 and 6. The present disclosure provides an embodiment, specifically a new type of fully degradable plastic compact includes a bottom cover 3, an inner side of the bottom cover 3 is provided with a bottom frame 5, an inner side of the bottom frame 5 is provided with a powder compact 7, an inner side of the powder compact 7 is filled with makeup powder, an upper end surface of the bottom frame 5 is provided with an upper cover 1, an inner side of one end of the upper cover 1 is rotationally connected with two plastic nails 12, axes of the two plastic nails 12 coincide, the two plastic nails 12 are inserted into the inner side of the bottom frame 5, the upper cover 1 and the bottom frame 5 are rotationally connected through the two plastic nails 12, and outer surfaces of the plastic nails 12 are provided with a plurality of positioning convex strips 15, so that the plastic nails 12 interfere with the upper cover 1 through the positioning convex strips 15 during a rotation of the upper cover 1 to realize a rotation positioning and non-detachment.

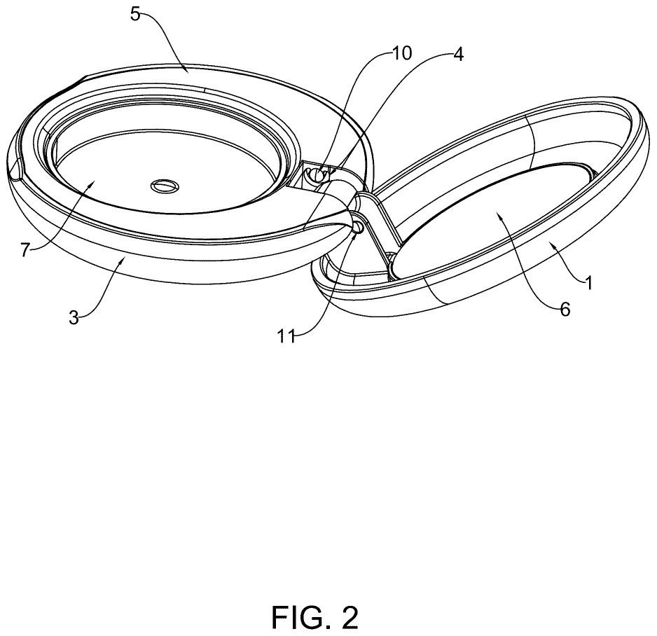

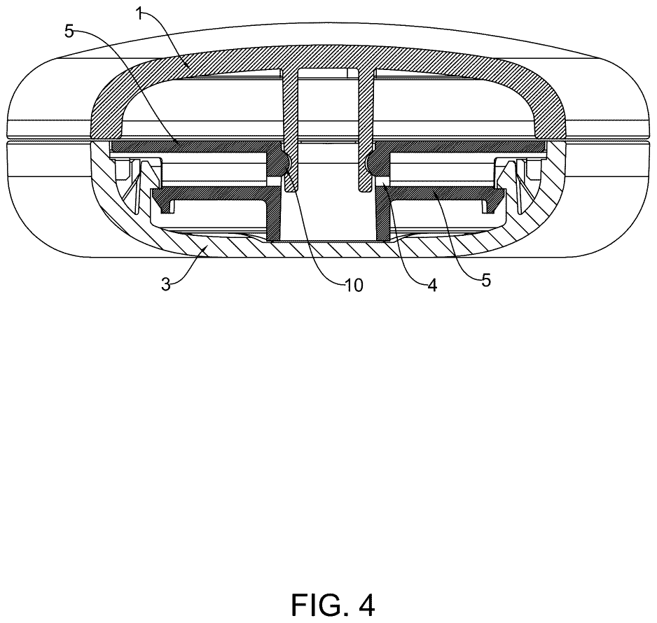

Please refer to FIGS. 2 to 4. Two positioning convex blocks 10 are provided on an inner side of one end of the bottom frame 5. The bottom frame 5 and the two positioning convex blocks 10 are injection molded as a whole. One side of the positioning convex blocks 10 is provided with an arc-shaped recess 4, and two sides of one end of the upper cover 1 are provided with positioning recesses 11. The bottom frame 5 and one end of the upper cover 1 are connected by the two positioning convex blocks 10 and the positioning recesses 11. The positioning convex blocks 10 are in a suspended state relative to the arc-shaped recess 4. The arc-shaped recess 4 can make the positioning convex blocks 10 in a suspended state, thereby providing greater elastic space when the positioning convex blocks 10 and the positioning recesses 11 are engaged and separated, and improving the service life of the positioning convex blocks 10.

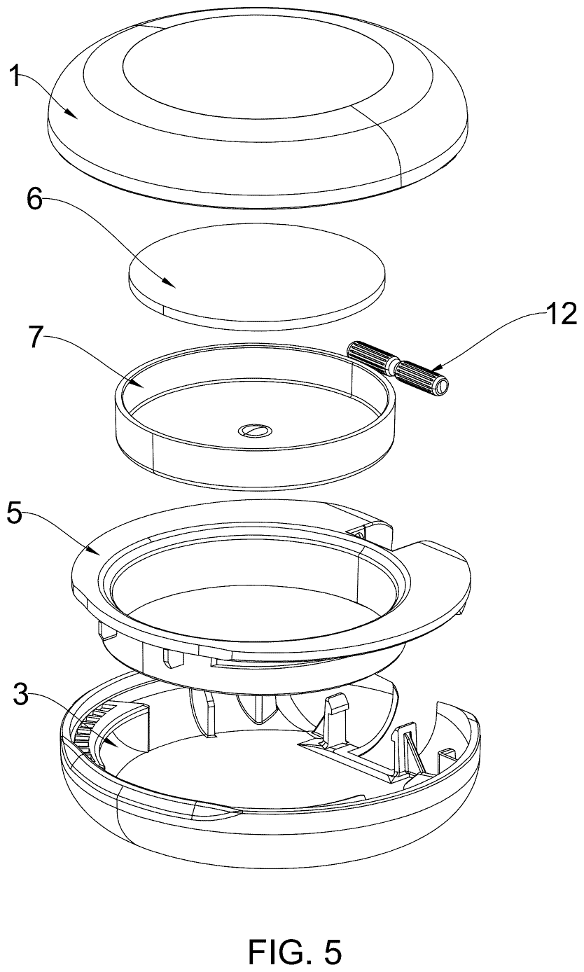

Please refer to FIGS. 1 and 5. A label layer 2 is provided in a middle of an upper end face of the upper cover 1. The bottom cover 3 is clamped with the bottom frame 5. The materials of the upper cover 1, the bottom cover 3, the bottom frame 5, the powder compact 7, and the plastic nails 12 are all biodegradable PET plastic, which can achieve overall degradation and recycling operations and is conducive to environmental protection.

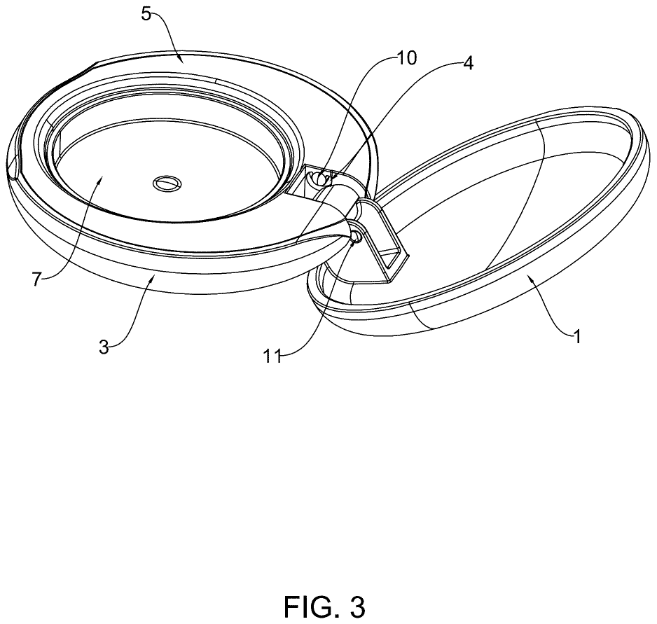

Please refer to FIGS. 2 and 3. The material of the upper cover 1 can be opaque PET plastic, and a plastic mirror 6 is bonded and fixed to an inner wall of the upper cover 1. The material of the upper cover 1 can also be transparent PET plastic.

In an implementation mode, the plastic nails 12 can be divided into three usage scenarios.

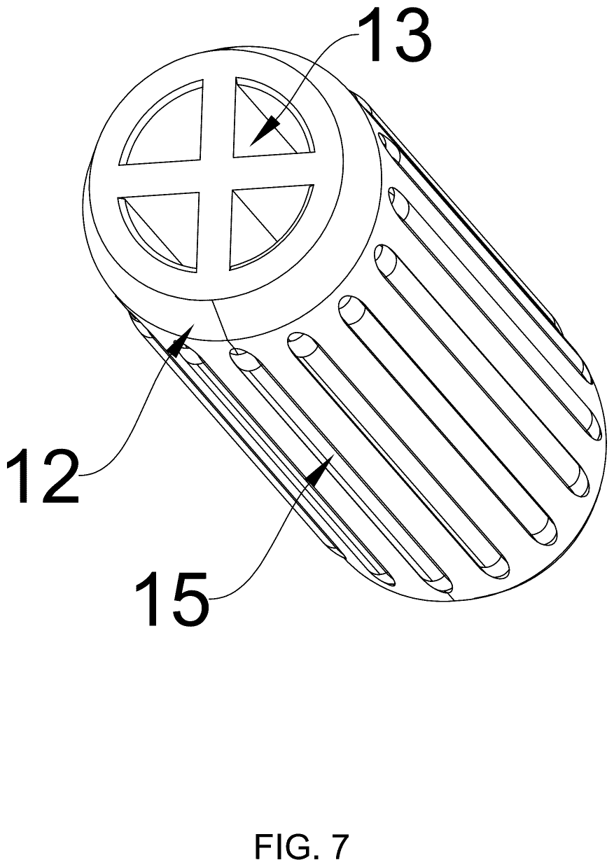

Please refer to FIG. 7, where inner sides of two ends of plastic nails 12 are fixedly provided with reinforcement ribs 13. The plastic nails 12, the positioning convex strips 15, and the reinforcement ribs 13 are injection molded as a whole.

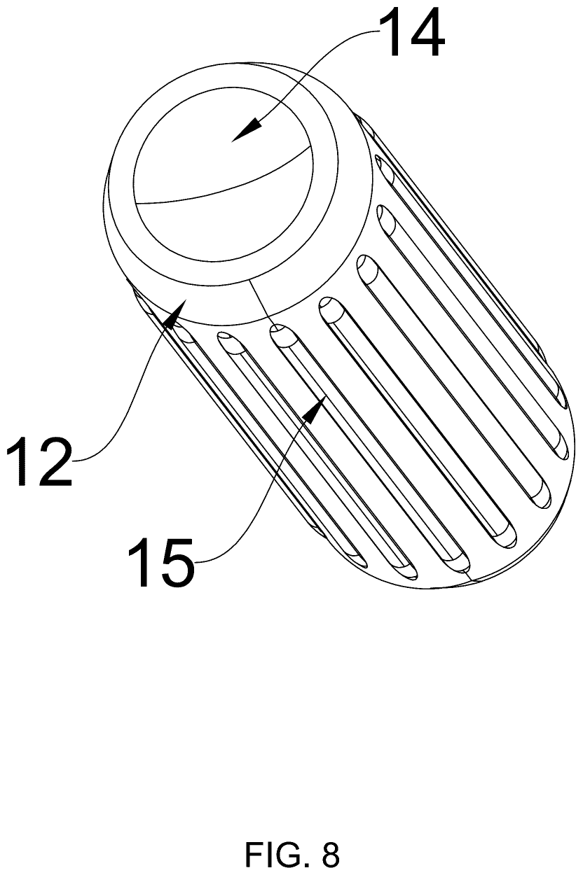

Please refer to FIG. 8, or one end of the plastic nails 12 is provided with an anti-deviation groove 9, and inner sides of two ends of the plastic nails 12 are provided with central holes 8. Adjacent two central holes 8 are not communicated, and the plastic nails 12 are injection molded as a whole with the plurality of positioning convex strips 15.

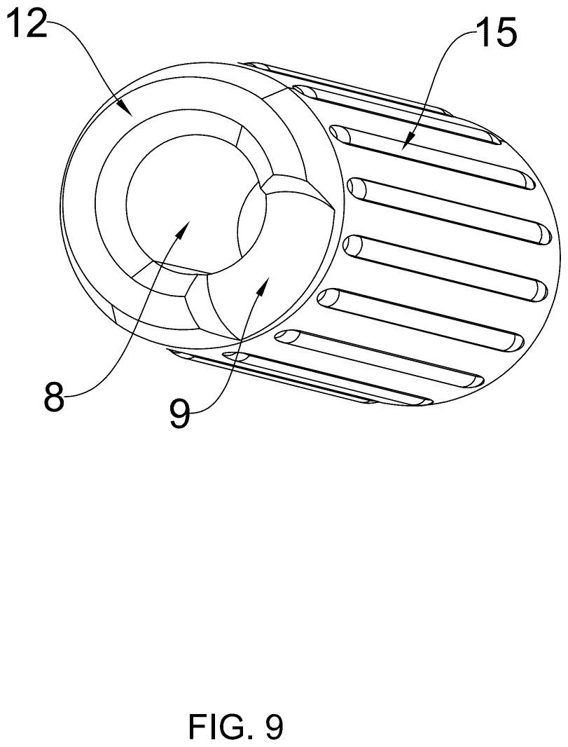

Please refer to FIG. 9, or two ends of the plastic nails 12 are provided with reinforcement grooves 14, and the plastic nails 12 are injection molded as a whole with the plurality of positioning convex strips 15.

When in use, the inner side of the bottom cover 3 is clamped with the bottom frame 5, so that the bottom frame 5 is easy to store makeup powder through the powder compact 7 and sealed and closed through the upper cover 1. The materials of the upper cover 1, the bottom cover 3, the bottom frame 5, the powder compact 7, and the plastic nails 12 are all biodegradable PET plastic, which can achieve degradation and recycling operation and is conducive to environmental protection. Two plastic nails 12 are provided on the inner side of one end of the upper cover 1, so that the upper cover 1 and the bottom frame 5 are rotatably connected by the two plastic nails 12. When opening and closing the upper cover 1, the upper cover 1 rotates relative to the bottom frame 5 through the plastic nails 12. The plurality of positioning convex strips 15 are provided on the outer sides of the plastic nails 12, so that the plastic nails 12 interferes with the upper cover 1 through the positioning convex strips 15 during the rotation process to achieve rotational positioning and non-detachment.

There are two positioning convex blocks 10 on the inner side of one end of the bottom frame 5, and two positioning recesses 11 on two sides of one end of the upper cover 1. By hiding the positioning convex blocks 10 and the positioning recesses 11, the overall aesthetic effect can be improved. At the same time, there are arc-shaped recess 4 on one side of the positioning convex blocks 10, which can make the positioning convex blocks 10 in a suspended state, thereby providing greater elastic space when the positioning convex blocks 10 and the positioning recesses 11 are engaged and separated, and improving the service life of the positioning convex blocks 10.

When the upper cover 1 and the bottom cover 3 are closed, the positioning convex blocks 10 and the positioning recesses 11 are interlocked, thereby maintaining the stability of the upper cover 1 in a closed state and avoiding accidental contact that may cause the powder inside the powder compact 7 to spill.

For those skilled in the art, it is apparent that the present disclosure is not limited to the details of the exemplary embodiments described above, and can be implemented in other specific forms without departing from the spirit or basic features of the present disclosure. Therefore, from any point of view, the embodiments should be regarded as exemplary and non-limiting, and the scope of the present disclosure is limited by the appended claims rather than the above description. Therefore, it is intended to include all changes falling within the meaning and scope of the equivalent elements of the claims in the present disclosure.

What is claimed is:

1. A degradable plastic compact, comprising: a bottom cover,
wherein a bottom frame is provided on an inner side of the bottom cover, a powder compact is provided on an inner side of the bottom frame, an inner side of the powder compact is filled with makeup powder, and an upper cover is provided on an upper end face of the bottom frame; two plastic nails are rotatably connected to an inner side of one end of the upper cover, and axes of the two plastic nails coincide;
the two plastic nails are inserted into the inner side of the bottom frame, and the upper cover is rotatably connected to the bottom frame through the two plastic nails, an inner side of one end of the bottom frame is provided with two positioning convex blocks, and one side of the positioning convex blocks is provided with an arc-shaped recess; two sides of one end of the upper cover are provided with positioning recesses.

2. The degradable plastic compact according to claim 1, wherein a label layer is provided in a middle of an upper end face of the upper cover, the bottom cover is clamped with the bottom frame,
materials of the upper cover, the bottom cover, the bottom frame, the powder compact and the plastic nails are all degradable PET plastic,
the bottom frame and the two positioning convex blocks are injection molded as a whole,
the bottom frame and one end of the upper cover are clamping connected by the two positioning convex blocks and the positioning recesses;
the positioning convex blocks are suspended relative to the arc-shaped recess.

3. The degradable plastic compact according to claim 2, wherein a plastic mirror is adhered and fixed to an inner wall of the upper cover, and material of the upper cover is opaque PET plastic.

4. The degradable plastic compact according to claim 2, wherein material of the upper cover is transparent PET plastic.

5. The degradable plastic compact according to claim 3, wherein outer surfaces of the plastic nails are provided with a plurality of positioning convex strips, and inner sides of two ends of the plastic nails are fixedly provided with reinforcement ribs;
the plastic nails, the positioning convex strips, and the reinforcement ribs are injection molded as a whole.

6. The degradable plastic compact according to claim 3, wherein outer surfaces of the plastic nails are provided with a plurality of positioning convex strips, and two ends of the plastic nails are provided with reinforcement grooves;
the plastic nails and the plurality of positioning convex strips are injection molded as a whole.

7. The degradable plastic compact according to claim 3, wherein outer surfaces of the plastic nails are provided with a plurality of positioning convex strips, one end of the plastic nails is provided with an anti-deviation groove, and inner sides of two ends of the plastic nails are provided with central holes;
adjacent two central holes are not communicated, and the plastic nails and the plurality of positioning convex strips are injection molded as a whole.
